(19) United States
(12) Patent Application Publication
(10) Pub. No.: US 2009/0135341 A1
(43) Pub. Date: May 28, 2009

(54) BACKLIGHT ASSEMBLY, LIQUID CRYSTAL DISPLAY HAVING THE SAME, AND METHOD OF MANUFACTURING BACKLIGHT ASSEMBLY

(76) Inventors: Min-Jeong Wang, Seoul (KR); Kyung-Min Kim, Asan-si (KR); Seok-Hyun Nam, Seoul (KR); Sang-Hyuck Yoon, Seoul (KR); Hyun-Jin Kim, Yongi-si (KR); Dong-Chin Lee, Chunan-si (KR); Seon-Bae Kim, Asan-si (KR)

Correspondence Address: F. CHAU & ASSOCIATES, LLC, 130 WOODBURY ROAD, WOODBURY, NY, 11797, US

(21) Appl. No.: 12/274,952

(22) Filed: Nov. 20, 2008

(30) Foreign Application Priority Data
Nov. 23, 2007 (KR) 10-2007-0120197

(51) Int. Cl. G02F 1/13357; H01J 1/00; H01J 9/00

(52) U.S. Cl. 349/71; 362/97.1; 445/23

(57) ABSTRACT

The present invention relates to a backlight assembly, in which a lamp starting performance can be improved and an assembly process can be simplified, a liquid crystal display having the backlight assembly, and a method of manufacturing the backlight assembly. A backlight assembly according to the present invention includes a body, a phosphor film formed on an inside of the body, and an afterglowing material film formed on the outside of the body. Accordingly, a dark starting time can be shortened by improving a lamp starting performance of a light source.

This application claims the benefit of priority of Korean Patent Application No. 10-2007-0120197 filed on Nov. 23, 2007, the contents of which are hereby incorporated by reference herein in their entirety.

### BACKGROUND OF THE INVENTION

1. Technical Field

The present disclosure relates to a backlight assembly, a liquid crystal display having the same, and a method of manufacturing the backlight assembly, and more particularly, to a backlight assembly, in which the lamp starting performance can be improved and an assembly process can be simplified, a liquid crystal display having the backlight assembly, and a method of manufacturing the backlight assembly.

2. Description of the Related Art

In general, a liquid crystal display (LCD) is a display apparatus for displaying an image using liquid crystals with optical and electrical characteristics, including an anisotropic refractive index, an anisotropic dielectric constant, and the like. As compared with other display apparatuses such as a cathode ray tube (CRT), a plasma display panel (PDP), or the like, the LCD has beneficial features such as small thickness, light weight, low driving voltage and low power consumption. Therefore, the LCD has been widely used in the display apparatus industry.

An LCD typically includes an LCD panel having a thin film transistor (TFT) substrate, a color filter substrate opposite to the TFT substrate, and a liquid crystal layer interposed between both the substrates to change light transmissivity. In addition, as the LCD panel for displaying an image is not a self light-emitting device, the LCD needs a backlight assembly for supplying light to the LCD panel.

A conventional backlight assembly has a light source for generating light. The light sources for the backlight assembly may be classified as either a linear light source, a surface light source and a point light source. The linear light sources include a cold cathode fluorescent lamp (CCFL), a hot cathode fluorescent lamp (HCFL) and an external electrode fluorescent lamp (EEFL). The linear light sources have been used mainly in backlight assemblies due to their price competitiveness.

The CCFL includes a glass tube, and electrodes provided in both ends of the glass tube. The glass tube is filled with a discharge gas such as mercury (Hg), argon (Ar) and neon (Ne). The discharge gas may be changed according to the kind of a lamp to be used. In addition, a phosphor film is applied on an inside surface of the glass tube. When a high voltage is applied to both the electrodes of the lamp, electrons may be released from the electrodes due to an electric field. The term ‘cold cathode’ is attributed to the fact that the electrons may be released not by heat but by an electric field. The released electrons may excite Hg and the excited Hg may emit ultraviolet light. The ultraviolet light may then be converted into visible light by the phosphor film, and the visible light may be emitted to the outside.

However, the CCFL may have a difficulty associated therewith in that when it is left in a dark state for a long time, the lamp lighting time may be delayed. That is, ions and electrons in the CCFL may be more stabilized when it is left in the dark state for a long time, as compared with a case where the CCFL is left in the dark state for a short time. As the ions and electrons should be excited again when lighting the lamp, it may take time to excite the ions and electrons.

In addition, when a plurality of linear light source type CCFLs are arranged in a backlight assembly, there may be difficulties in deciding an arrangement direction. The linear lamp has a phosphor film formed to have a thickness gradient in a lengthwise direction. It thus may be necessary to arrange the lamps so that the amount of phosphor film applied to one lamp mutually complements the amount of phosphor film applied to another adjacent lamp. In the conventional art, to distinguish the arrangement direction, the degree of application of phosphor film is different depending on a lengthwise direction of a single lamp. That is, a region to which a phosphor film is not applied is formed longer in one end and shorter in the other end, which, may in turn, cause the whole length of the lamp to be increased. Further, the size of the backlight assembly in which the lamp is mounted may also be increased.

### SUMMARY OF THE INVENTION

Exemplary embodiments of the present invention may provide a backlight assembly, in which a dark starting time can be shortened by improving a lamp starting performance, a liquid crystal display having the same, and a method of manufacturing the backlight assembly.

Exemplary embodiments of the present invention may provide a backlight assembly and a liquid crystal display, in which an arrangement direction of light sources can be easily recognized when assembling the backlight assembly, thereby improving the assembling efficiency.

In accordance with an exemplary embodiment of the present invention, a backlight assembly is provided. The backlight assembly includes at least one light source. The at least one light source includes a body, a phosphor film formed on an inside of the body, and a afterglowing material film formed on the outside of the body.

Here, the at least one light source may be a linear one, and the afterglowing material film may be formed on at least one end of the at least one light source. The phosphor film may have a thickness gradient in a longitudinal direction.

In addition, the afterglowing material film may be formed on one end of the light source, the at least one light source may be a plurality of light sources arranged in a line. One end of the plurality of light sources having the afterglowing material film formed thereon and the other end thereof having no afterglowing material film formed thereon may be arranged to alternate with each other in an arrangement direction of the light sources.

The afterglowing material film may include one of a fluorescent material or phosphor. The afterglowing material film may include at least one selected from the group consisting of Sr₂MgSi₂O₇, (Sr,Ca)MgSi₂O₇, BaAl₂O₄, CaAl₂O₄, CaAl₄O₇, Ca₂Al₂SiO₇, MgAl₂O₄, SrAl₂O₄, SrAl₄O₇, Sr₄Al₁₄O₂₅ and Zn₁₁Si₄B₁₀O₃₄. The persistent time of the afterglowing material film may be at least about 10 hours.

In addition, the backlight assembly may further include a receiving member for fixing the at least one light source, materials for the afterglowing material film being mixed with or applied to the receiving member. Here, the receiving member may be at least one of a support for supporting the light source, a cover for leading light emitted from the light source, an optical portion, and a mold portion. The optical portion may include at least one of a reflection sheet, a diffusion plate, a light guide plate, a diffusion sheet, a prism sheet and a protection sheet.

Here, the at least one light source may be at least one of a cold cathode fluorescent lamp, a hot cathode fluorescent lamp and an external electrode fluorescent lamp.

In accordance with an exemplary embodiment of the present invention, a liquid crystal display is provided. The liquid crystal display includes a liquid crystal display panel having a plurality of pixels formed thereon and a backlight assembly including at least one light source to supply light to the liquid crystal display panel. The at least one light source having a body, a phosphor film formed on an inside of the body, and an afterglowing material firm formed on the outside of the body.

In accordance with another exemplary embodiment of the present invention, a method of assembling a backlight assembly is provided. The method includes preparing at least two linear light sources having an afterglowing material film formed on one ends of each of the at least two linear light sources and distinguishing the one ends of the at least two linear light sources having the afterglowing material film formed thereon and arranging the at least two linear light sources.

Here, the afterglowing material film may be formed by one of a rolling or dipping process. The one ends of the at least two linear light sources having the afterglowing material film formed thereon and the other ends thereof having no afterglowing material film formed thereon may be alternately arranged.

At this time, the afterglowing material film may include one of a fluorescent material or phosphor. The afterglowing material film may include at least one selected from the group consisting of Sr₂MgSi₂O₇, (Sr,Ca)MgSi₂O₇, BaAl₂O₄, CaAl₂O₄, CaAl₄O₇, Ca₂Al₂SiO₇, MgAl₂O₄, SrAl₂O₄, SrAl₄O₇, Sr₄Al₁₄O₂₅ and Zn₁₁Si₄B₁₀O₃₄.

In addition, the method may further include preparing a receiving member for fixing the at least two linear light sources, wherein materials for the afterglowing material film are mixed with or applied to the receiving member.

Also, the method may further include forming a phosphor film on an inside of the at least two linear light sources, the phosphor film having a thickness gradient in a longitudinal direction.

### BRIEF DESCRIPTION OF THE DRAWINGS

Exemplary embodiments of the present invention can be understood in more detail from the following description taken in conjunction with the accompanying drawings, in which:

FIG. 1A is a perspective view illustrating a light source according to an exemplary embodiment of the present invention;

FIG. 1B is a longitudinal sectional view of FIG. 1A;

FIG. 2 is a schematic view illustrating a comparison of the light source according to an exemplary embodiment of the present invention with a conventional light source;

FIG. 3 is a perspective view schematically illustrating a backlight assembly according to an exemplary embodiment of the present invention;

FIG. 4 is a perspective view schematically illustrating a backlight assembly according to an exemplary embodiment of the present invention; and

FIG. 5 is a perspective view schematically illustrating a liquid crystal display according to an exemplary embodiment of the present invention.

### DETAILED DESCRIPTION OF THE EXEMPLARY EMBODIMENTS OF THE INVENTION

Hereinafter, exemplary embodiments of the present invention will be described in detail with reference to the accompanying drawings.

However, the present invention is not limited to the exemplary embodiments disclosed below but may be implemented into different forms. Throughout the drawings, like reference numerals are used to designate like elements.

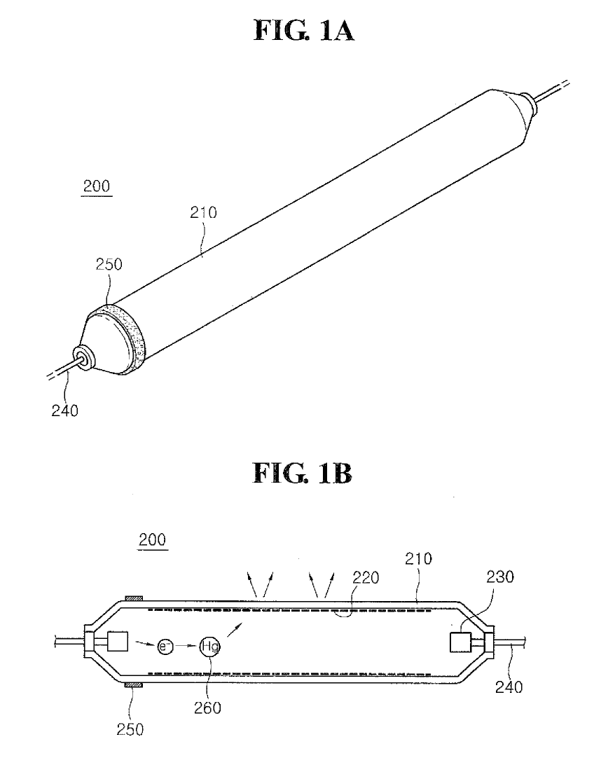

FIG. 1A is a perspective view illustrating a light source according to an exemplary embodiment of the present invention, and FIG. 1B is a longitudinal sectional view of FIG. 1A. The following figures including FIG. 1A are schematic views in which size and shape of each element is appropriately exaggerated for convenience of understanding.

Referring to FIGS. 1A and 1B, a light source 200 according to an exemplary embodiment of the present invention includes a body 210, a phosphor film 220 formed on the inside of the body 210, and an afterglowing material film 250 formed on the outside of the body 210. Here, the body 210 may be, for example, a glass tube and filled with a discharge gas 260.

The light source 200, in this exemplary embodiment, is a cold cathode fluorescent lamp (CCFL). For example, the light source may be a linear light source, which includes the glass tube 210 defining an external appearance of the light source 200, lamp electrodes 230 formed at both ends of the glass tube 210, lamp wires 240 connected to the lamp electrodes 230, the phosphor film 220 formed on the inner wall surface of the glass tube 210, and the discharge gas 260 with which the glass tube 210 is filled. The lamp electrodes 230 are connected to an inverter through the lamp wires 240 to be supplied with voltage. In this embodiment, the discharge gas 260 of the light source 200 includes, for example, mercury (Hg). In addition, the discharge gas 260 may further include, for example, argon (Ar) and neon (Ne) to facilitate discharge. When a high voltage is applied to both the lamp electrodes 230 of the light source 200, electrons may be released from the lamp electrodes 230 by an electric field. The released electrons may excite Hg, and the excited Hg may emit ultraviolet light. The emitted ultraviolet light may be converted into visible light by the phosphor film 220, and the visible light may be emitted to the outside. As described above, the discharge gas 260 and the phosphor film 220 in the glass tube 210 constitute a light generation portion to generate light.

The light source 200 has a phosphor region coated with the phosphor film 220 in a lengthwise direction, and non-phosphor regions not coated with the phosphor film 220 in both ends, e.g., both end portions at which the electrodes 230 are provided.

The phosphor film 220 is not formed near both the ends of the light source 200, more specifically, in the regions of a predetermined length from the electrodes, e.g., in the non-phosphor regions. As the phosphor film 220 is not formed, no light emission may occur in the non-phosphor regions.

Independently of the phosphor film 220, the afterglowing material film 250 is formed on any one or both of the non-phosphor regions formed at both the ends of the light source 200. The afterglowing material film 250 may be formed to surround the light source 200 in the circumferential direction perpendicular to the lengthwise direction of the light source 200, and formed on the light source 200 partially in the circumferential direction. For example, the afterglowing material film 250 may be formed on the outside of the glass tube 210. As the afterglowing material film 250 is formed on the outside of the non-phosphor region of the light source 200, it may not affect the light emission characteristic of an effective light emission region where the light emission of the light source 200 occurs, e.g., the phosphor region.

When the light source 200 is manufactured, the afterglowing material film 250 may be formed through, for example, a rolling process, in which an afterglowing material is applied to the outer surface of the light source 200 by driving a roll, a dipping process, in which the light source 200 is dipped in a bath of an afterglowing material, or other processes. For example, the process may be performed simultaneously with a lot numbering process.

Here, the afterglowing material film 250 includes, for example, a fluorescent material or phosphor. The afterglowing material film 250 may include, for example, at least one selected from the group consisting of Sr₂MgSi₂O₇, (Sr,Ca)MgSi₂O₇, BaAl₂O₄, CaAl₂O_{4, CaAl}₄O₇, Ca₂Al₂SiO₇, MgAl₂O₄, SrAl₂O₄, SrAl₄O₇, Sr₄Al₁₄O₂₅ and Zn₁₁Si₄B₁₀O₃₄, or the selected material doped with another material. In addition to the aforementioned materials, it is possible to use any fluorescent material that can emit light by itself or any phosphor that can emit light for an extended period of time in a state where atoms are excited by light. Moreover, it is possible to use, as the afterglowing material, a material with a persistent time of about 10 hours or more, and more preferably, about 20 hours or more, for which light is emitted in a dark state without a supply of external light energy.

The following Table 1 shows light emission wavelengths and persistent time of the aforementioned afterglowing materials.

TABLE 1

| Afterglowing | | Persistent time |
|---|---|---|
| material | Light emission wavelength (nm) | (hour) |
| Sr₂MgSi₂O₇ | 466 | 20 |
| (Sr,Ca)MgSi₂O₇ | 490 | 20 |
| BaAl₂O₄ | 412, 450 | 12 or more |
| CaAl₂O₄ | 413 | 12 or more |
| CaAl₄O₇ | 543 | 10 |
| Ca₂Al₂SiO₇ | 550 | 10 |
| MgAl₂O₄ | 520 | 10 |
| SrAl₂O₄ | 385, 427 | 12 or more |
| SrAl₄O₇ | 475 | 10 or more |
| Sr₄Al₁₄O₂₅ | 424, 486 | 15 |
| Zn₁₁Si₄B₁₀O₃₄ | 590 | 12 |

As shown in Table 1, the materials exemplified for the afterglowing material film 250 according to the embodiment of the present invention have a persistent time of about 10 hours or more. For example, Sr₂MgSi₂O₇ and (Sr,Ca)MgSi₂O₇ have a relatively long persistent time of about 20 hours and a relatively high light emission wavelength of about 400 nm. Thus, Sr₂MgSi₂O₇ and (Sr,Ca)MgSi₂O₇ are more preferably used for the afterglowing material film 250 of the exemplary embodiments of the present invention.

In general, initial electrons and ions existing in the light source 200 facilitate the discharge when lighting the lamp. A lamp starting performance is varied upon the residual amount of the initial electrons and ions. Therefore, in a case where the lamp is left in the dark state for a long time, a large amount of electrons and ions are stabilized. As the electrons and ions should be excited again when lighting the lamp, an initial lamp lighting time is delayed. The longer the lamp is left in the dark state, the more the electrons and ions are stabilized, which causes the initial lamp lighting time to be more delayed.

However, according to exemplary embodiments of the present invention, when the light source 200 is left in the dark state, the afterglowing material film 250 formed on the light source 200 may emit light for the persistent time, so that the initial electrons and ions may continuously exist in the light source 200. Therefore, a dark state staying time of the light source 200 may be reduced, whereby a lighting time of the light source 200 can be shortened when lighting the lamp.

If the afterglowing material film 250 is formed adjacent to the electrode 230, as the amount of the initial electrons and ions in the electrode 230 can be increased, it may be beneficial in the initial lighting of the lamp. In addition, when a large amount of initial electrons and ions exist in the light source 200, not only the lamp lighting time can be shortened but also an initial voltage can be dropped when lighting the lamp. The low initial voltage of the light source 200 can contribute to the improvement of driving stability and reliability.

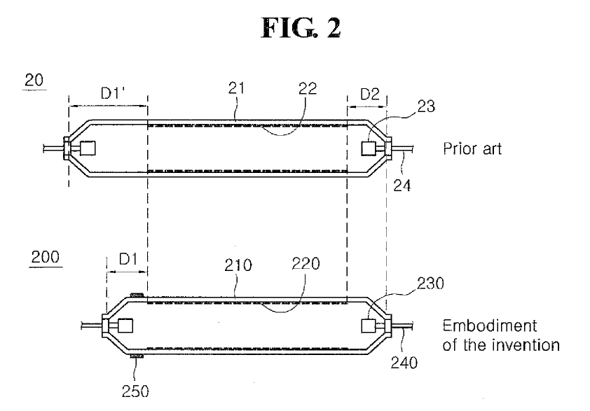

FIG. 2 is a schematic view illustrating a comparison of the light source according to an exemplary exemplary embodiment of the present invention with a conventional light source.

A conventional lamp 20 has non-phosphor regions at both ends in a lengthwise direction, wherein the non-phosphor regions are formed asymmetrical. That is, any one non-phosphor region D1′ is formed longer than the other non-phosphor region D2. For example, the non-phosphor region D1′ is 8 mm and the non-phosphor region D2 is 5 mm. The reason to form the non-phosphor regions different from each other is as follows.

That is, when manufacturing the lamp 20, a hollow glass tube 21 is suspended in a lengthwise direction and supplied with a phosphor solution, so that a phosphor film 22 is formed on the inside of the glass tube 21. At this time, the phosphor film 22 has a thickness gradient due to the gravity, wherein the phosphor film 22 is thick on the lower end of the suspended glass tube 21 and becomes thin as it goes to the upper end thereof. When a plurality of lamps 20 having the phosphor film 22 with the thickness gradient are arranged in a line in a backlight assembly of a display apparatus, it may be necessary to arrange the lamps 20 so that the thickness gradient of the phosphor film 22 of one of the lamps 20 can complement the thickness gradient of the phosphor film 22 of another adjacent lamp 20. That is, when the phosphor film 22 of one of the lamps 20 is placed in a thick-thin direction, the phosphor film 22 of another adjacent lamp 20 should be placed in a thin-thick direction. In this arrangement, the light emission luminance of the display apparatus using the lamps 20 as a light source is uniform.

To readily recognize the thick-thin direction of the phosphor film 22 of the conventional lamp 20, any one end of the lamp, e.g., the non-phosphor region D1′, is elongated to be distinguished from the other end thereof, e.g., the non-phosphor region D2, thereby causing the lamps 20 to be readily arranged.

However, according to an exemplary embodiment of the present invention, the afterglowing material film 250 is formed on any one end of the lamp, e.g., the non-phosphor region D1 to distinguish the thickness gradient of the phosphor film 220. That is, the afterglowing material film 250 is formed on the non-phosphor region D1 in which the phosphor film 220 is formed thick or thin, instead of forming any one of the non-phosphor regions D1 and D2 of the light source 200 to be longer than the other. Therefore, as a result, the thickness gradient of the phosphor film 220 may be readily distinguished.

The present exemplary embodiment will be compared with the conventional example. As any one end of the lamp 20, for example, the non-phosphor region D1′ is elongated, the entire length of the lamp 20 is relatively long. However, in the present exemplary embodiment of the present invention, the non-phosphor regions D1 and D2 of both the ends of the light source 200 can have the same length (D1=D2), and the non-phosphor region D1 of any one end need not be elongated (D1′>D1). Although the light source 200 has the same phosphor region as that of the conventional lamp 20, the length of the light source 200 can be reduced by (D1′−D1).

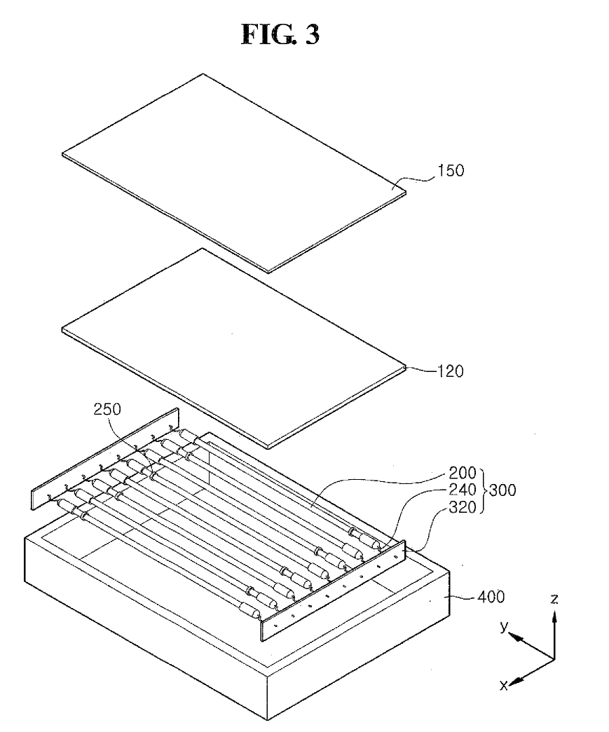

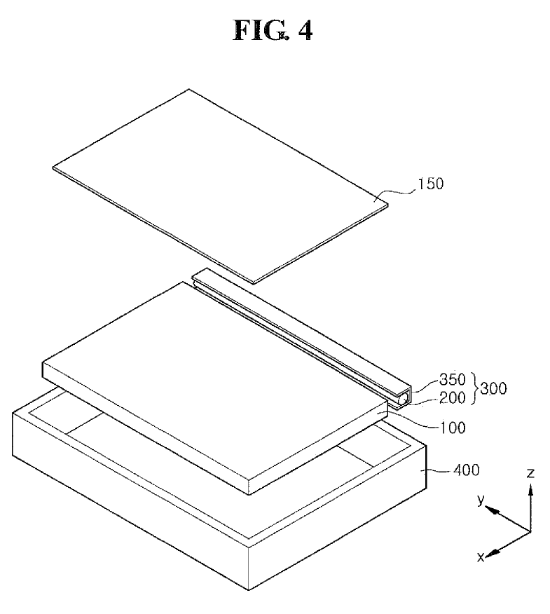

FIG. 3 is a perspective view schematically illustrating a backlight assembly according to an exemplary embodiment of the present invention. FIG. 4 is a perspective view schematically illustrating a backlight assembly according to another exemplary embodiment of the present invention.

Referring to FIG. 3, the backlight assembly according to an embodiment of the present invention includes a light source unit 300, a diffusion plate 120 provided over the light source unit 300, and a mold 400 for accommodating the light source unit 300 and the diffusion plate 120. An optical sheet 150 including a prism sheet may be provided over the diffusion plate 120.

The light source unit 300 includes a plurality of light sources 200, and lamp holders 320 provided at both ends of the light sources 200 to fixedly support the light sources 200. Lamp wires 240 of the light sources 200 may pass through the lamp holders 320 and be connected to an inverter. The lamp holders 320 or the lamp wires 240 are not limited to the aforementioned configuration, but may be modified in various shapes to fixedly support the plurality of light sources 200. CCFLs are preferably used as the plurality of light sources 200. The exemplary embodiments of the present invention are not limited thereto, but rather all kinds of lamps emitting light in an infrared wavelength region as well as visible light (e.g., white light) may be employed as the lamp. The CCFLs can be the light sources 200 explained above with reference to FIGS. 1A to 2. In the CCFL, electrons released through an electric field applied between an anode and a cathode may cause a state transition of Hg thereby emitting light in a predetermined wavelength region, and a phosphor may convert the light in the predetermined wavelength region into visible light to emit the visible light. At this time, the light is emitted in a direction toward the optical sheet 150, e.g., in the +z-direction, through the diffusion plate 120.

In addition, HCFLs may be used as the light sources 200. Moreover, each of the HCFLs may include a glass tube filled with a mixed gas of mercury (Hg) and an inert gas such as krypton (Kr) and argon (Ar), electrodes disposed at both ends of the glass tube, and a phosphor film formed on an inside surface of the glass tube. In the HCFL, thermal electrons released through an electric field applied between the electrodes may cause a state transition of Hg thereby emitting light in a predetermined wavelength region, and the phosphor then may convert the light in the predetermined wavelength region into visible light to emit the visible light.

The diffusion plate 120 may evenly diffuse the light emitted from the light source unit 300 on the x-y plane, and may cause the light to exit in the z-direction.

In the backlight assembly, an afterglowing material film may be formed on at least one of the light source unit 300, the diffusion plate 120, the optical sheet 150 and the mold 400. The afterglowing material may be the same material as the afterglowing material explained with reference to FIGS. 1A to 2. However, another afterglowing material may also be employed depending on characteristics of a member on which the afterglowing material film is formed.

The afterglowing material may be applied to at least one of the members including the afterglowing material, e.g., the light source unit 300, the diffusion plate 120, the optical sheet 150 and the mold 400. In addition, the aforementioned various members may be manufactured by adding the afterglowing material into the members. The afterglowing material film may be formed, for example, to face a light generation portion of the aforementioned various members, e.g., a region, in which light is generated, including a discharge gas and a phosphor film.

In addition, as shown in FIG. 4, the backlight assembly according to another exemplary embodiment of the present invention may include a light source 200 provided in a lateral side of a light guide plate 100 and a cover portion 350 for directing the light from the light source 200 to the light guide plate 100, as a light source unit 300. Here, the light guide plate 100 converts the light of the light source 200 having a light distribution of a linear light source shape into light having a light distribution of a surface light source. In FIG. 4, a afterglowing material film may be formed on the cover portion 350.

An LCD having a backlight assembly according to an exemplary embodiment of the present invention will be described.

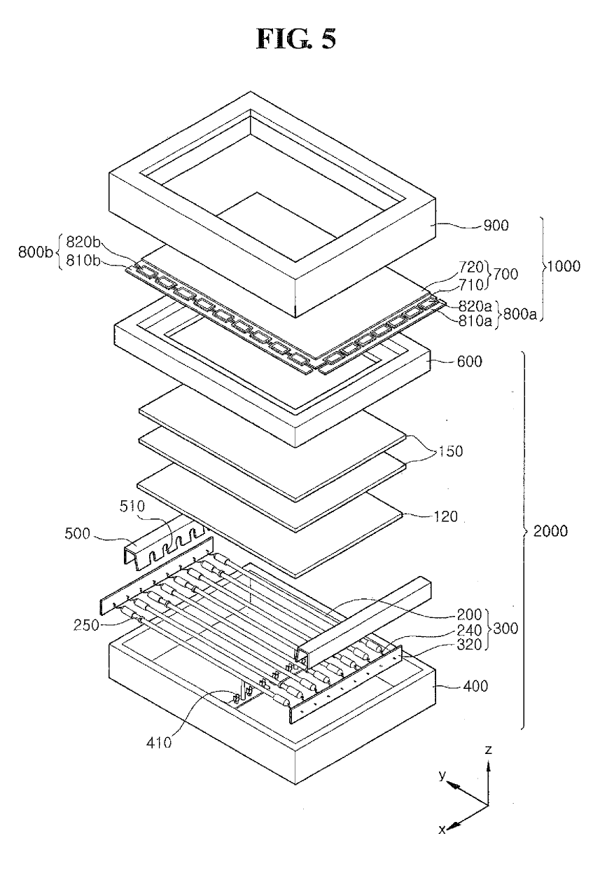

FIG. 5 is a perspective view schematically illustrating a liquid crystal display according to an exemplary embodiment of the present invention.

Referring to FIG. 5, the LCD according to an exemplary embodiment of the present invention includes a display assembly 1000 disposed in an upper portion of the LCD, and a backlight assembly 2000 disposed in a lower portion thereof.

The display assembly 1000 includes an LCD panel 700, a driving circuit unit 800 (800a and 800b), and an upper mold 900.

The LCD panel 700 includes a color filter substrate 720 and a TFT substrate 710. The driving circuit unit 800 includes a gate side printed circuit board 810a connected to gate lines of the TFT substrate 710 through a gate side flexible printed circuit board 820a, and a data side printed circuit board 810b connected to data lines of the TFT substrate 710 through a data side flexible printed circuit board 820b. If necessary, the gate side printed circuit board 810a can be omitted.

The upper mold 900 may be manufactured in the shape of a quadrangular frame with plane and sidewall portions bent at a right angle to prevent the elements of the display assembly 1000 from escaping and to protect the liquid crystal display panel 700 or the backlight assembly 2000, which may be fragile from an external impact. At this time, the plane portion of the upper mold 900 partially supports the edges of the liquid crystal display panel 700 at a lower part of the plane portion, and the sidewall portion is coupled to sidewalls of a lower mold 400. The upper mold 900 and the lower mold 400 may be made of, for example, a metal with superior strength, light weight and less-deformable property.

Then, the backlight assembly 2000 includes a light source unit 300 for generating light, fixing members 500 for fixedly supporting the light source unit 300, a diffusion plate 120 placed on the fixing members 500, an optical sheet 150 arranged over the diffusion plate 120, a middle mold 600 for supporting the diffusion plate 120 and the optical sheet 150, and the lower mold 400 for accommodating the light source unit 300, the fixing members 500, the diffusion plate 120 and the optical sheet 150.

The light source unit 300 includes a plurality of light sources 200 arranged at regular intervals, and lamp holders 320 provided at both ends of the light sources 200. In this embodiment, the light sources 200 are arranged so that a lengthwise direction of the light sources 200, e.g., an x-direction is perpendicular to a major axis direction of the lower mold 400, e.g., a y-direction. The exemplary embodiments of the present invention are not limited thereto, but the light sources 200 may be arranged in the y-direction so that the lengthwise direction of the light sources 200 is parallel to the major axis direction of the lower mold 400.

The light sources 200 may be arranged, for example, so that non-phosphor regions having afterglowing material film 250 formed thereon alternate with non-phosphor regions having no afterglowing material film formed thereon. That is, when a phosphor film 220 of any one of the light sources 200 is arranged thick or thin at any one side of the light source unit, a phosphor film 220 of another adjacent light source 200 can be arranged thin or thick at the one side thereof to complement the thickness.

The fixing member 500 is manufactured as a frame with an open lower portion to surround the lamp holder 320. Concave portions 510 are formed in one side of the fixing member 500 to surround the light sources 200. Accordingly, the fixing members 500 fixedly support the lamp holder 320 to thereby prevent the light sources 200 from shaking and protect the light sources 200 from an external impact. The fixing member 500 is not limited to the aforementioned structure, but may be modified in various shapes to fixedly support the plurality of light sources 200 of the light source unit 300.

The diffusion plate 120 provided on the fixing members 500 diffuses the incident light emitted from the light source unit 300 to be uniformly distributed in a wide range, so that the light is directed toward the front surface of the liquid crystal display panel 700. Here, the diffusion plate 120 and the optical sheet 150 are not limited to the aforementioned structure.

The optical sheet 150 may include at least one prism sheet, at least one polarization sheet, at least one luminance improving sheet, and at least one diffusion sheet. The polarization sheet may serve to change the inclined components of the incident light to exit perpendicularly to the polarization sheet. The luminance improving sheet may transmit light parallel to its transmission axis and reflects light perpendicular to its transmission axis. The diffusion sheet may diffuse the incident light to have a light distribution of a surface light source and then allows the light to exit. Therefore, the light can be incident on the liquid crystal display panel 700 in a perpendicular direction thereto, thereby improving light efficiency. The optical sheet 150 may be provided over the diffusion plate 120, and attached to the diffusion plate 120 in the light emission direction, e.g., the z direction. In this case, the thickness of the backlight assembly 2000 and the LCD can be reduced.

The middle mold 600 may be manufactured in the shape of a quadrangular frame to support the diffusion plate 120 and the optical sheet 150 and also to support the liquid crystal display panel 700 thereon.

The lower mold 400 is formed in the shape of, for example, a rectangular hexahedral box with an open top face, and a receiving space with a predetermined depth defined in the lower mold 400. A plurality of lamp supporters 410 are provided in the lower mold 400 to support the light sources 200 of the light source unit 300, thereby preventing the light sources 200 from sagging or being damaged due to an external impact. A plurality of the lamp supporters 410 may support each of the light sources 200. A reflection plate may be provided on a bottom surface of the lower mold 400. The aforementioned afterglowing materials may also be applied to the lamp supporters 410.

Here, in the non-phosphor regions of the light sources 200 having the afterglowing material film 250 formed thereon, the light emitted from the afterglowing material film 250 to the liquid crystal display panel 700 can be blocked by any one of the fixing members 500, the lower mold 400 and the lamp holders 320. In this situation, the light emitted from the afterglowing material film 250 or the inherent color of the afterglowing material film 250 does not appear from the outside. The afterglowing material film 250 may only serve to enable the large amount of initial electrons and ions to exist in the light sources 200.

The backlight assembly according to another exemplary embodiment of the present invention explained with reference to FIG. 4 can be applied as the backlight assembly 2000 in the LCD.

According to exemplary embodiments of the present invention, a dark starting time can be shortened by improving a lamp starting performance of a light source.

In addition, according to exemplary embodiments of the present invention, an arrangement direction of the light sources can be readily recognized when assembling a backlight assembly thereby improving the assembling efficiency.

Moreover, according to exemplary embodiments of the present invention, the production yield of LCDs can be improved and a cost thereof can be cut down by readily arranging the light sources.

Further, according to exemplary embodiments of the present invention, the lamp starting performance of the LCD can be improved.

Having described the exemplary embodiments of the present invention, it is further noted that it is readily apparent to those of reasonable skill in the art that various modifications may be made without departing from the spirit and scope of the invention which is defined by the metes and bounds of the appended claims.

What is claimed is:

1. A backlight assembly comprising:
at least one light source,
the at least one light source including:
a body;
a phosphor film formed on an inside of the body; and
an afterglowing material film formed on the outside of the body.

2. The backlight assembly as claimed in claim 1, wherein the at least one light source is a linear light source, and the afterglowing material film is formed on at least one end of the light source.

3. The backlight assembly as claimed in claim 2, wherein the phosphor film has a thickness gradient in a longitudinal direction.

4. The backlight assembly as claimed in claim 1, wherein the at least one light source is a plurality of light sources arranged in a line, and wherein one end of the plurality of light sources having the afterglowing material film formed thereon and the other end of the plurality of light sources having no afterglowing material film formed thereon are arranged to alternate with each other in an arrangement direction of the light sources.

5. The backlight assembly as claimed in claim 1, wherein the afterglowing material film includes one of a fluorescent material or phosphor.

6. The backlight assembly as claimed in claim 1, wherein the afterglowing material film includes at least one selected from the group consisting of Sr₂MgSi₂O₇, (Sr,Ca)MgSi₂O₇, BaAl₂O₄, CaAl₂O₄, CaAl₄O₇, Ca₂Al₂SiO₇, MgAl₂O₄, SrAl₂O₄, SrAl₂O₄, SrAl₄O₇, Sr₄Al₁₄O₂₅ and Zn₁₁Si₄B₁₀O₃₄.

7. The backlight assembly as claimed in claim 1, wherein a persistent time of the afterglowing material film is at least about 10 hours.

8. The backlight assembly as claimed in claim 1, further comprising a receiving member for fixing the at least one light source, wherein materials for the afterglowing material film are mixed with or applied to the receiving member.

9. The backlight assembly as claimed in claim 8, wherein the receiving member is at least one of a support for supporting the at least one light source, a cover for leading light emitted from the at least one light source, an optical portion, and a mold portion.

10. The backlight assembly as claimed in claim 9, wherein the optical portion comprises at least one of a reflection sheet, a diffusion plate, a light guide plate, a diffusion sheet, a prism sheet and a protection sheet.

11. The backlight assembly as claimed in claim 1, wherein the at least one light source is at least one of a cold cathode fluorescent lamp, a hot cathode fluorescent lamp and an external electrode fluorescent lamp.

12. A liquid crystal display, comprising:
a liquid crystal display panel having a plurality of pixels formed thereon; and
a backlight assembly including at least one light source to supply light to the liquid crystal display panel, the at least one light source having a body, a phosphor film formed on an inside of the body, and an afterglowing material firm formed on the outside of the body.

13. A method of assembling a backlight assembly, comprising:
preparing at least two linear light sources having an afterglowing material film formed on one end of each of the at least two linear light sources ; and
distinguishing the ends of the at least two linear light sources having the afterglowing material film formed thereon and arranging the at least two linear light sources.

14. The method as claimed in claim 13, wherein the afterglowing material film is formed by one of a rolling or dipping process.

15. The method as claimed in claim 13, wherein the ends of the at least two linear light sources having the afterglowing material film formed thereon and the other ends thereof having no afterglowing material film formed thereon are alternately arranged.

16. The method as claimed in claim 13, wherein the afterglowing material film includes one of a fluorescent material or phosphor.

17. The method as claimed in claim 13, wherein the afterglowing material film includes at least one selected from the group consisting of Sr₂MgSi₂O₇, (Sr,Ca)MgSi₂O₇, BaAl₂O₄, CaAl₂O₄, CaAl₄O₇, Ca₂Al₂SiO₇, MgAl₂O₄, SrAl₂O₄, SrAl₄O₇, Sr₄Al₁₄O₂₅ and Zn₁₁Si₄B₁₀O₃₄.

18. The method as claimed in claim 13, further comprising preparing a receiving member for fixing the at least two linear light sources, wherein materials for the afterglowing material film are mixed with or applied to the receiving member.

19. The method as claimed in claim 13, further comprising forming a phosphor film on an inside of the at least two linear light sources, wherein the phosphor film has a thickness gradient in a longitudinal direction.
